(19) United States
(12) Patent Application Publication
(10) Pub. No.: US 2016/0339542 A1
(43) Pub. Date: Nov. 24, 2016

(54) ADDITIVE MANUFACTURING APPARATUS AND METHOD FOR OPERATING THE SAME

(71) Applicant: Dominique Paetz, Verden (DE)

(72) Inventor: Dominique Paetz, Verden (DE)

(21) Appl. No.: 15/187,116

(22) Filed: Jun. 20, 2016

Related U.S. Application Data
(63) Continuation of application No. PCT/EP2014/078507, filed on Dec. 18, 2014.

(30) Foreign Application Priority Data
Dec. 20, 2013 (DE) 102013021944.2

(51) Int. Cl. B23K 26/342; B33Y 10/00; B23K 26/06; B23K 26/03; B23K 26/144; B33Y 30/00; B22F 3/00

(52) U.S. Cl. CPC B23K 26/342; B33Y 30/00; B33Y 10/00; B22F 3/008; B23K 26/03; B23K 26/144; B23K 26/0626

(57) ABSTRACT

A rapid prototyping device for the layered additive manufacturing of three-dimensional objects with a manufacturing base and at least one manufacturing head, which is developed to dispense manufacturing material selectively according to location at the manufacturing site in grid positions according to predetermined manufacturing grids for each layer. In order to create a prototyping device which ensures fast and accurate three-dimensional workpieces in layers with the possibility of processing a plurality of manufacturing materials, a fuser unit of the manufacturing head is developed to fuse the manufacturing material located on the respective grid positions to the grid positions selectively according to location.

### CROSS-REFERENCED APPLICATION

This application is a by-pass continuation application of PCT International Application No. PCT/EP2014/078507, filed on Dec. 18, 2014, which claims priority to German Patent Application No. 10 2013 021 944.2, filed on Dec. 20, 2013, both of which are incorporated herein in their entireties by reference thereto.

### BACKGROUND

1. Field of the Disclosure

The disclosure relates to a rapid prototyping device for the layer-by-layer additive fabrication of three-dimensional objects. The disclosure also relates to a method of operating such a rapid prototyping device.

2. Discussion of the Background Art

Rapid prototyping is a broad term for the manufacturing of three-dimensional objects, such as models, patterns, prototypes or tools. Manufacturing is performed directly on the basis of predefined data models. The computer representation of the object to be manufactured can, for example, be generated with the aid of a computer by using CAD software. In this process, the computer analyses the representation and generates a level shift schedule of the object to be manufactured, whereby, for each layer, a manufacturing grid can be generated, from which can be observed at which cells of the grid location-selective manufacturing materials are to be deposited and consolidated. In this way, the rapid prototyping device constructs the three-dimensional work piece layer by layer. Such manufacturing processes are also known under the umbrella term “additive manufacturing”. Rapid prototyping manufacturing processes implement existing design information directly and quickly into work pieces with as few detours or forms as possible. Instead of prototypes, other objects, such as tools or finished parts, can of course be produced, whereby the rapid prototyping of tools is referred to as “rapid tooling” and the rapid prototyping of tools is referred to as “rapid manufacturing”. What is common to all processes, however, is the manufacturing of three-dimensional objects according to specifications of existing design information, such as CAD data.

Various rapid prototyping processes are known by means of which different materials can be processed at different manufacturing speeds.

In principle, the prototyping devices for the rapid prototyping of three-dimensional objects have at least one manufacturing head for the configuration of manufacturing material on a manufacturing base or on the manufacturing base of previously produced material layers. The manufacturing base on which the three-dimensional object is built up layer by layer, and at least one manufacturing head, are arranged against each other in a relocatable manner both according to a working direction in the plane of a layer as well as in the feed direction, relative to the thickness of the layers. For example, the manufacturing head can be moved over a manufacturing base in a web form, which is immovable in the plane of the layer, in order to deposit material at each crossing of the manufacturing location.

The rapid prototyping device further comprises a fuser unit for attaching the deposited or arranged manufacturing material to the already deposited layers of material.

Selective laser sintering is a process for producing three-dimensional objects through sintering from a manufacturing material which is in powder form. This manufacturing material will be applied as a thin powder bed onto the manufacturing base or the layers of material which are already deposited under it. A fuser unit, which is usually a laser, warms up the manufacturing material selectively according to location, corresponding to the predetermined manufacturing information, so that, at the particular location, the manufacturing material is sintered and transferred in a solid state. The manufacturing material is a powder, which is mixed with one or more sintered components, so that, after melting, a solid material is obtained from the fuser unit after cooling of the molten mass. A rapid prototyping device for laser sintering therefore cannot process pure materials, since a sinter mixture is generally solidified. Moreover, the operation is relatively slow, since cooling of the recently-processed material layer has to be waited for after melting and sintering, before the powder bed can be applied for the next layer of material.

If work pieces are produced from a pure material, i.e. without a binder, the manufacturing material powder (such as a metal powder) will become completely melted. Such prototyping devices with correspondingly powerful lasers are associated with selective laser melting.

US 2005/093 208 A1 discloses a rapid prototyping device and a method for rapid prototyping, whereby a manufacturing head produces a powdered storage material in layers and releases an initiator substance responding to ultraviolet light selectively according to location. As a result of the layer being exposed to a large surface area of ultraviolet light, a cross-connection of the manufacturing material is only produced in the areas that are defined by the initiator substance which is sprayed on selectively according to location. The unbonded portions of the powder bed are treated as a support material and removed.

An alternative to the rapid prototyping processes, which essentially operate with the location-selective melting of powdered material in a powder bed, is a rapid prototyping method which is similar to the operating principle of an inkjet printer under the designation “multi jet modelling” or “poly-jet modelling”. In this process, a print head has several nozzles which are arranged in a linear fashion. The multi jet prototyping devices process meltable plastics, in particular hard waxes, or wax-like thermoplastic materials, and can produce very fine droplets. As a result, they achieve high degrees of surface-finish quality. However, the manufacturing head of the poly jet prototyping device has to travel long distances driven by a motor and only works on the work piece intermittently, so that the achievable manufacturing rates, while perhaps sufficient for the manufacturing of prototypes or models (“rapid prototyping”), are not sufficient for industrial applications involving serial or mass manufacturing.

From US 2011/0061591 A1, a rapid prototyping device for layered rapid prototyping of three-dimensional objects is known with a manufacturing head which is developed to form a metallic work piece from molten manufacturing material layer for layer by a plurality of deposits which have been successively deposited on a manufacturing table. It comprises a material supply which is designed to supply metallic manufacturing materials in the form of a wire. An electron gun melts the supplied metallic manufacturing materials. The manufacturing process takes place in an evacuation chamber of a housing of the prototyping device. The electron gun is arranged at an adjustable distance relative to the manufacturing table, so that a metallic work piece is gradually built up.

Since the manufacturing head with the metallic wire has to work together with the electron gun and can only approach the next working position after the melting process has been completed, the manufacturing speed of the known prototyping device does not meet the requirements of industrial applications involving serial or mass manufacturing.

WO 95/26871 A1 discloses a rapid prototyping device of which the manufacturing head has an electrostatically chargeable drum. The shell of the rotating drum is ionised with a latent image in order to accumulate powdery manufacturing material through electrostatic attraction to the ionised sites. Upon further rotation, the drum releases the manufacturing material onto a dielectric belt conveyor, which leads its cargo through a device in which the powder is rendered tacky, such as by heat. The tacky layer is ultimately driven by the belt conveyor over a manufacturing board and connected there to the board or the top layer of the already stacked stack by means of mechanical pressure.

### SUMMARY

The objective of the present disclosure is to produce a rapid prototyping device of the generic type which ensures a quick and accurate layered manufacturing of three-dimensional work pieces with the possibility of processing multiple manufacturing materials.

This object is achieved according to the disclosure by means of a rapid prototyping device and by a method for operating such a device.

According to the disclosure, the fuser unit of the prototyping device is developed so that at the respective grid positions, the manufacturing material located there will be attached selectively according to location. The fuser unit administers energy to the manufacturing material selectively according to location, namely to the specific working position corresponding to the grid position in the manufacturing grid, in order to heat and melt the manufacturing material. The fuser unit has such a configuration that the energy provided for melting is applied in a focused manner according to location, precisely at the specific grid positions at which the manufacturing material had previously been deposited selectively according to location. With location-selective and precise fusing, significantly higher fusing speeds can be achieved than is the case with conventional fusing over larger surface areas of the deposited material layer. In particular, the present location-selective fusing pursuant to the disclosure allows for a concentration of energy which is available for the fusing, so that, if necessary, a large amount of energy has to be applied and, with a view to saving energy, only has to be applied for grid positions which are actually equipped with manufacturing material.

Furthermore, the location-selective fusing in the combination according to the disclosure, with its location-selective material delivery of the manufacturing head, allows, according to the predetermined manufacturing grids for each layer, a significantly higher manufacturing rate than the known prototyping devices with a material supply over a powder bed, particularly in manufacturing with various manufacturing materials.

The disclosure has proven to be particularly suitable for manufacturing materials with active properties, such as antimicrobial properties, dirt resistance, reduced formation of deposits, easy-to-clean materials, hydrophilic/hydrophobic qualities, oleophilic/oleophobic qualities, low or high adhesion, high corrosion resistance, high electrical conductivity or electrical insulation, high thermal conductivity or thermal insulation, improved biocompatibility, improved or reduced high-frequency conductivity, defined reflection properties (in particular light, UV, IR, radio waves), scratch resistance, hardness, improved temperature stability, passive layers/passivity, catalytic properties, defined friction behaviour, defined vacuum behaviour, improved solderability/weldability, static or antistatic properties, improved pigmentability, UV protection, doping with metals, nanoparticles and/or nanostructures, multi-layered surfaces or multifunctional surfaces.

In one advantageous embodiment of the disclosure, the fuser unit is controlled by means of a control unit acting upon it according to the manufacturing grids for each respective layer. The control unit is configured so as to determine grid positions and/or performance information for the fuser unit according to the predetermined manufacturing grid for the current material layer which is to be produced. The control unit provides the fuser unit with grid positions corresponding to the manufacturing grid, on which the fuser unit is activated selectively according to location and acts on the selectively deposited manufacturing material.

Advantageously, the control unit of the fuser unit provides not only grid positions at which the fuser unit is activated and, thus, manufacturing material is to be melted and fixed, but also a power requirement which is linked to the respective grid position in the manufacturing grid, i.e. which is provided for this grid position. As a result, the energy requirement includes this information about the requested power of an energy source of the fuser unit and/or about the temporal duration of the effect of the fuser unit on the manufacturing material. The disclosure thereby enables a fast manufacturing of objects that consist of several materials. The energy requirement is thereby matched to the physical properties of the particular material which is to be fused, such as its melting point. Furthermore, the determination of the energy requirement takes into account a certain surface quality after fusing or similar properties. Through the location-selective storage of manufacturing materials and their likewise location-selective fusing with additional consideration of individual energy requirements, different materials with a melting point above 500° C. and/or a melting point difference greater than 100° C. to 500° C. can, for example, be fused. Furthermore, materials with melting point differences of less than 10° C. can also be realised location-selectively and accurately with a suitable control of the energy input to the grid position to be fused, taking into account the melting point of the respective material.

A rapid and accurate attachment of the manufacturing material to the manufacturing base or already deposited layers of material is provided when the fuser unit of the manufacturing head includes a laser and an optical deflection device which is assigned to the laser. The deflection device is preferably a rotating mirror, in particular a hexagonal mirror, which, in the manner of a laser scanner, deflects the laser beam of the laser to the points which are to be fused. In the process, the laser beam heats the places which are targeted selectively according to location and melts the manufacturing material located there, which is then cooled and which becomes part of the work piece which is to be manufactured. Fuser units with light sources that work in the ultraviolet range selectively according to location have shown to be advantageous and suitable alternatives to a laser. Infrared or microwave sources, especially focused microwave sources (such as plasma lasers), are suitable as alternative heat sources.

Through the location-selective fusing of the manufacturing material according to the disclosure, very precise manufacturing with small intervals of the grid positions in the manufacturing grid is possible, including with grid widths of less than one centimetre, particularly in the embodiment with a laser as an energy source. Pure-material objects can thereby be generated if unmixed manufacturing material, such as a metal powder, is deposited and melted by the laser beam. For the processing of different materials, the disclosure also provides for grid position intervals of less than one millimetre. The disclosure thereby also allows for distances of less than 0.1 mm. Distances of less than 0.05 mm to one of the other materials are also feasible in the indicated embodiment of the disclosure. Through the location-selective fusing of the manufacturing material according to the disclosure, particularly in the embodiment with a laser as an energy source, the realisable manufacturing distance of 0.1 mm (for example) is also taken into account in the three-dimensional space. Very thin material layers can be applied through the location-selective fusing according to the disclosure. In determining the location-selective manufacturing information, the thickness of the layers of material which are to be produced is adapted for fusing through a manufacturing software with the grid positions for the location-selective manufacturing and the location-selective energy requirement. In one advantageous embodiment of the disclosure, a presented body which has already been processed by the prototyping device is coated with the desired thickness.

In one advantageous embodiment of the disclosure, the manufacturing head is developed so as to deliver manufacturing material in screen printing to the manufacturing base or the already-deposited layers of material. The manufacturing head therefore has such a configuration and design which enables it, during screen printing processes, to dispense manufacturing material pursuant to the provided manufacturing grid for the respective layer selectively according to location. The manufacturing head thereby advantageously comprises a fine-meshed fabric or screen through which the manufacturing material is pressed onto the manufacturing base or the already deposited layer. This purpose is served, for example, by a rubber roller or the like. The mesh size of the sieve is thereby matched to the intended manufacturing grid.

As an alternative to the material feed in screen printing, the manufacturing head in a further embodiment of the disclosure is developed so as to dispense manufacturing material selectively in offset printing according to location. The waterless offset printing process is seen as being particularly suitable in this context.

In a further advantageous embodiment of a method for operating a rapid prototyping device according to the disclosure, manufacturing occurs under certain environmental conditions, such as a certain pressure, temperature or atmosphere, in order to achieve optimum manufacturing results. As a result, the disclosure's scope of application is expanded, and even sensitive materials can be processed. For example, in one advantageous embodiment, a vacuum is created for this purpose in the manufacturing area and produced at lower pressures of less than 0.1 bar. Alternatively, or additionally, the manufacturing process is promoted by means of the specific configuration of the manufacturing environment. The configuration can thereby provide a protective atmosphere with gases such as CO₂, Ar, He, Ne, Xe or N. Further, in specific manufacturing situations, the manufacturing atmosphere takes into consideration the function atmospheres, i.e. those configurations in which the presence of certain substances and/or thermodynamic conditions promotes or even enables the location-selective manufacturing process with certain manufacturing materials.

In a particularly preferred embodiment of the disclosure, such training of at least one manufacturing head is provided so that the manufacturing material can, pursuant to the principle of electrophotography, be received selectively according to location and transported to the manufacturing location. The working principle of electrophotography is known from the application in two-dimensional laser printers. The disclosure has recognised, however, that a significantly higher manufacturing rate can be achieved with the greatest possible accuracy by means of the working principle of electrophotography. Compared to the selective laser melting, a much higher manufacturing rate is provided, since the manufacturing material does not have to be heated layer by layer. Furthermore, the loss of manufacturing material is significantly reduced, particularly in the case of different manufacturing materials, since no impurities are formed.

The manufacturing head of the prototyping device according to the disclosure comprises an electrophotographic imaging drum, which carries a photoconductor on its shell and is exposed in the region of a material transfer of the manufacturing head in relation to the manufacturing base. The image drum is a rotatably-mounted component which extends transversely to the working direction of the manufacturing head in its axial direction. During the operation of the prototyping device, the image drum is moved in a working direction of rotation and passed over the manufacturing base. In this process, small, location-selective quantities of material are transported to the place of manufacture and stored there after having been placed on the photoconductor the image drum pursuant to the principle of electrophotography. The manufacturing base is a substantially horizontal arrangement of the prototyping device, upon which the three-dimensional object is built up in layers by means of depositing and solidifying the manufacturing material. Advantageously, the working table of the prototyping device is the manufacturing base. In an embodiment of rapid prototyping device according to the disclosure configured for serial or mass manufacturing, a belt conveyor forms the manufacturing base, upon which the ever increasing number of manufacturing locations can be moved into the working area of the manufacturing heads for the layered additive construction of three-dimensional objects.

If the image drum is assigned to a heater, the manufacturing material is heated prior to the transfer to the manufacturing basis, thus reducing the energy required for the melting process in the context of the fusing. It is advantageous that the image drum is kept at a substantially constant temperature level by the heating device, whereby the temperature level is advantageously adjustable.

The prototyping device also includes an electrical conditioning device for the electrostatic charging of the photoconductor of the image drum and at least one exposure unit. This exposure unit encompasses a means for the location-selective exposure of the photoconductor of the image drum corresponding to the predetermined manufacturing information for the three-dimensional object or product. This exposure unit is disposed downstream in the working direction of rotation of the imaging drum of the electrical conditioning unit. In operation of the prototyping device, the conditioning unit electrostatically loads the portion of the imaging drum facing it. For this purpose, the conditioning unit advantageously comprises corona wires, i.e. thin wires which are attached near the imaging drum and put under high voltage and which produce a corona discharge. In one alternative embodiment of the disclosure, the conditioning device comprises a series of dot charging diodes which are arranged parallel to the axial direction of the imaging drum and charge each facing surface line of the photoconductor electrostatically. The point load diodes are those diodes for which the emission is sufficient for a local ionisation or electrostatic charging. Several point charging diodes juxtaposed in a row thereby act together on a surface line of the photoconductor. If the imaging drum is rotated further, each subsequent surface line is charged electrostatically.

After the conditioning of the photoconductor, the exposure unit exposes the photoconductor according to the predetermined manufacturing information. As a result, in one advantageous embodiment, the exposure can be deleted at the points where manufacturing material is to be applied to the image drum later. At the exposed areas, the photoconductor is conductive and thereby loses its charge. In one alternative embodiment, the exposure unit exposes a negative print image, whereby those sites are exposed selectively according to location which are not intended to accept any manufacturing material later.

The manufacturing head also includes a development unit which is arranged downstream of the exposure unit in the operating direction of rotation of the image drum and which receives at least one electrostatically chargeable transfer roller for supplying manufacturing material. The transfer roller, of which there is at least one, is parallel to the image drum. Each transfer leads an opposition layer to its shell via manufacturing material which contains electrostatic forces, and on which opposition layer the shell of the imaging drum and the shell of the transfer roller are adjacent to each other in the shortest distance. In this opposition layer, manufacturing material is transferred from the transfer roller to the image drum at those locations of the imaging drum which were previously not exposed by the exposure unit. In one embodiment of the disclosure, the imaging unit generates a positive image on the photoconductor, whereby the manufacturing material is ionised negatively on the transfer roller. In one embodiment with negative pressure imaging, the manufacturing material is positively ionised.

Finally, the manufacturing head according to the disclosure comprises an electrical base conditioning which is arranged in the working direction of rotation of the image drum before the transfer of material to the manufacturing base and which acts in the direction of the manufacturing base. In one advantageous embodiment of the disclosure, this base conditioning includes corona wires. In another embodiment of the disclosure, the base conditioning comprises a row of point charging diodes which are arranged transversely to the working direction of the manufacturing head and which can be activated when passing the construction location or the material layers which have already been placed on the manufacturing base. The electric charge that generates the base conditioning is greater in magnitude than the charge of the photoconductor of the image drum such that, in the opposition layer of the image drum on the material transfer, the amounts of material which are delivered on the image drum are removed from the imaging drum and are transferred at the intended manufacturing location to the manufacturing layer or the material layers upon which deposits have already been placed.

In an advantageous embodiment of the disclosure, the conditioning unit and/or the base conditioning which are assigned to the imaging drum are formed either for producing a negative electrostatic charge or for generating a positive electrostatic charge. As a result, the amount of manufacturing material which is able to be processed via the principle of the electrophotographic transport and fusing in the respective layer is significantly extended. The conditioning unit and/or the base conditioning are adjusted thereby for the polarity of the electrostatic charge which most closely corresponds to the chosen manufacturing material. Advantageously, the conditioning unit and/or the base conditioning between a setting for producing a negative electrostatic charge and a setting for generating a positive electrostatic charge are switchable.

In the aforementioned embodiment of the disclosure with the manufacturing of a positive print image on the photoconductor and the negative ionisation of the manufacturing material at the transfer roller, the base conditioning is designed and adjusted such that a positive charge is able to be generated.

In the embodiment of the disclosure with the generation of a negative print image on the photoconductor and the negative ionisation of the manufacturing material on the transfer roller, the base conditioning is designed and adjusted such that a negative charge can be generated. In both embodiments, the base conditioning is configured such that an amount of the electric charge which is producible by the base conditioning is greater than an amount of the charge of the photoconductor at the periphery of the image drum and which is producible from the conditioning unit, such that the location-selective transfer of manufacturing material from the image drum to the manufacturing location or the material layers which have already been deposited on the manufacturing base of the work piece is ensured.

In order to ensure the ionisation of the building material on the transfer roller, the transfer roller is associated with a charging unit. This charging unit generates electrostatic forces on the shell of the transfer roller which hold manufacturing material in place during transport to the imaging drum. In particular, for the processing of metallic materials, the supply of manufacturing material via an electrical manufacturing induction device, which is formed to produce an electric field in the conveying path of the manufacturing material to the transfer roller, is advantageous. The induction device is thereby a device which acts by means of an electric field via induction on the supplied manufacturing material. In the process, charge densities are transferred and generated location-dependently on the surface of the material particles. This physical phenomenon is known as induction or electrostatic induction. The induction device is therefore designed to generate an electric field in the conveying path of the manufacturing material and comprises an electrical voltage source for generating an electric field.

In one compact and reliable embodiment, the induction device includes a bladed conveyor wheel, the blades of which are electrically insulated and pass the electric field of an electric voltage source between a loading position and a dispensing position.

In order to safely receive the supplied manufacturing material, the transfer roller is electrically charged with the respective other polarity in relation to the induction device.

In one preferred embodiment of the disclosure, the developer unit includes a plurality of transfer rollers for each of the different manufacturing materials; these transfer rollers are held on a rotatable transfer carousel in such a way that one of the transfer rollers can be moved respectively in an active position adjacent to the imaging drum. The transfer carousel is adjustable in steps by means of a drive, in the manner of a revolver, for this purpose. In this way, objects can be made with different materials, whereby, even within a layer (namely, by briefly turning the transfer carousel), different materials can be incorporated. In this process, the formation of alloys is also possible.

In one preferred embodiment of the disclosure, the imaging unit includes a means for location-selective exposure of the photoconductor of the image drum of a laser, in particular of a pulsed laser, such as a CO2 laser, and a deflector assigned to the laser. The optical deflection is preferably a rotating mirror, in particular a hexagonal mirror, which deflects the laser beam of the laser line by line to the image drum in the manner of a laser scanner. The laser is turned on and off according to the predetermined manufacturing grids for each layer. Due to the exposure of the photoconductor by means of a laser, very high manufacturing speeds can be achieved, such that the prototyping device according to the disclosure is suitable not only for the manufacturing of prototypes, but also for industrial series or mass manufacturing.

In one alternative embodiment, the exposure unit has lined-up light sources as a means for the location-selective exposure of the photoconductor of the image drum in the axial direction of the image drum. These individual light sources are selectively controlled, according to the given manufacturing grids, such that the desired impression can be generated on the photoconductor before filling the photoconductor through the developing unit. The selectively controllable light sources are preferably LEDs.

A cleaning unit located in a return section of the image drum lying between the material feeding of the imaging drum and the conditioning unit is advantageous. The cleaning unit is favourably a material stripper which is disposed with the smallest possible gap on the shell of the imaging drum, such that any remaining material residues are removed from the periphery of the rotating drum. After the delivery of the manufacturing material from the imaging drum to the manufacturing location or the material layers which have already been deposited there, there might still be material remains on the shell of the image drum which are cleaned during the retracing to the conditioning unit where the image drum is conditioned for the next cycle.

For an initial work direction, the manufacturing head advantageously has an initial unit, each of which has at least one conditioning unit, exposure unit, developing unit, base conditioning and fuser unit, as well as a second device for one of the initial working devices opposite the second working direction. The second equipment set correspondingly includes at least one conditioning unit, an exposure unit, a developing unit, a base conditioning and a fuser unit, respectively, which is essentially disposed symmetrically to the initial device. In this way, the operating speed is doubled, due to the fact that at the end of a machining cycle, the working movement of the manufacturing head is changed in the plane of the layers, and the direction of rotation of the image drum is likewise changed. The first equipment set and the second equipment set are able to be activated alternatively, whereby the respective working directions of rotation of the image drum are set contrarily.

In one further advantageous embodiment of the disclosure, the prototyping device includes at least one manufacturing head as the main manufacturing head for the manufacturing material and another manufacturing head as a supporting manufacturing head for the supporting material, which can be controlled with the main manufacturing head in a coordinated fashion. The supporting manufacturing head thereby assigns supporting material within each of the layers of material which are to be produced and which is intended to support the respective subsequent layer of material. The support material enables the formation of undercuts and the like. The support material is removed after the manufacturing of the three-dimensional object, such as by water rinsing.

Advantageously, the supporting manufacturing head with respect to the array of image drum, conditioning unit, exposure unit, developer unit and base conditioning corresponds to the main manufacturing head. The support manufacturing head operates with a work rate which is similar to the main manufacturing head, such that a high overall working speed is provided. The fusing of the support manufacturing head is advantageously a heat source, such as an ultraviolet lamp.

In one embodiment of the disclosure, the fuser unit of the main manufacturing head is provided instead of a melting device, such as a laser, with a heat source, such as one or more ultraviolet lamps. Thereby, certain manufacturing materials can be applied which, for example, are applied in liquid form or are polymerised for the purpose of solidifying.

### BRIEF DESCRIPTION OF THE DRAWINGS

The disclosure is explained hereinafter with reference to the drawing. The drawing shows:

FIG. 1a perspective view of a first embodiment of a rapid prototyping device,

FIG. 2a perspective view of a second embodiment of a rapid prototyping device,

FIG. 3 a cross-section of an embodiment of a main manufacturing head for a rapid prototyping device pursuant to FIG. 1 or 2,

FIG. 4 a cross-section of an embodiment of a supporting manufacturing head for a rapid prototyping device pursuant to FIG. 1 or 2,

FIG. 5 a cross-section of a further embodiment of a main manufacturing head for a rapid prototyping device pursuant to FIG. 1 or 2,

FIG. 6 a cross-section of a further embodiment of a supporting manufacturing head for a rapid prototyping device pursuant to FIG. 1 or 2.

FIG. 7 a cross section of an embodiment of an induction device for supplying manufacturing materials.

### DETAILED DESCRIPTION OF THE PREFERRED EMBODIMENT

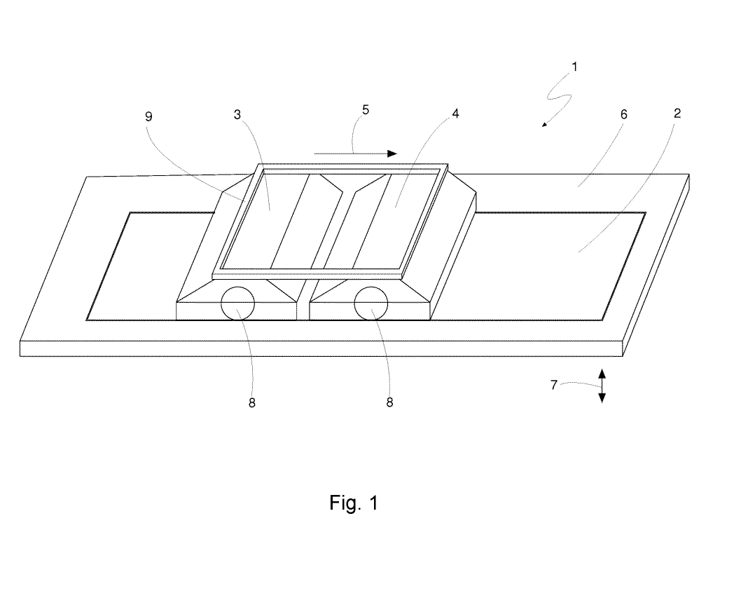

FIG. 1 shows a simplified representation of a rapid prototyping device 1 for layer-wise additive fabrication of three-dimensional objects. Rapid prototyping is understood to mean that manufacturing material is piled on a manufacturing base 2 of the prototyping device 1 and is added to the manufacturing material which is already located there. The manufacturing base 2 is the primarily horizontal work table of the prototyping device, upon which the three-dimensional object is built up in layers by means of depositing and solidifying manufacturing materials.

The prototyping device 1 comprises at least one manufacturing head 3, 4 for the location-selective array of manufacturing materials on the manufacturing base 2. In the illustrated embodiment, the prototyping device includes a main manufacturing head 3 for the location-selective array of manufacturing material and a supporting manufacturing head 4, for the arrangement of supporting material, which is applied during manufacture to support the following layers of material which are to be applied and is removed after finishing the manufacturing of the work piece. This support material enables the simple and accurate manufacturing of undercuts.

The manufacturing heads 3, 4 are located in a movable fashion in the plane of a layer or a plane of the manufacturing base 2 in accordance with an operating direction 5. The manufacturing heads 3, 4 are moved back and forth in the operation of the prototyping device 1 via the manufacturing base 2, whereby material may be arranged within a working area 6 on the manufacturing base or the layers of material which have already been deposited there. The main manufacturing head 3 and the supporting manufacturing head 4 are thereby driven in a coordinated fashion over the manufacturing base 2, which is symbolised in the diagram by the connection through a rigid frame 9. The manufacturing heads 3, 4 can be accommodated in the prototyping device in a shared housing.

On one hand, the manufacturing heads 3, 4 and the manufacturing base are arranged slidably in relation to each other in the direction of work 5. On the other hand, the manufacturing base 2 and the manufacturing heads 3, 4 are arranged slidably in a feed direction 7 with respect to the thickness of the layers. In this manner, after each work cycle (i.e. the application of a material layer), the distance between the manufacturing heads 3, 4 and the manufacturing base 2 is increased by the amount of one layer thickness. Before each operation of the manufacturing heads 3, 4, the distance between the manufacturing heads 3, 4 and each upper material layer of the unfinished three-dimensional work piece on the manufacturing base 2 is always the same.

In the illustrated embodiment, the work movement is realised in working direction 5 by a movement of the manufacturing heads 3, 4 over the manufacturing base 2. The manufacturing base 2 is adjustable and movable in feed direction 7. In further embodiments which are not illustrated, the relative movement between the manufacturing heads 3, 4 and the manufacturing base 2 is performed in the feed direction 7 by the manufacturing heads 3, 4. In another embodiment which is not illustrated, the manufacturing base 2 is movable in the direction of 5, while the manufacturing heads 3, 4 are fused in place.

The manufacturing heads 3, 4 are developed to arrange manufacturing material on the manufacturing base 2, or on the manufacturing material which is lying thereon, in a location-selective manner. The additive locating of the manufacturing material can be deposited and fused on the layers of material which have already been deposited on the manufacturing base 2 and/or on a pre-prepared body. In the latter embodiment, corresponding work pieces are layered. Location-selective arrangement is understood to mean that for each material layer of the object to be produced, a manufacturing grid is specified in which the locations provided for the depositing of manufacturing material or, in the case of the supporting manufacturing head, the locations which have been provided for the depositing of supporting material, are designated, and the material is arranged on the predetermined locations. The manufacturing grids are determined by a control unit (not illustrated here) on the basis of given design data, such as from a piece of CAD software, and the fabrication heads 3, 4 are controlled accordingly by a control unit (also not illustrated here).

Each manufacturing head 3, 4 has at least one image drum 8 (explained in more detail below), which can be equipped on its periphery corresponding to the predetermined manufacturing grids with manufacturing or support material and passed through the manufacturing base 2 during the working motion. Each surface line of the image drum 8 which is positioned in opposition to the manufacturing base 2 dispenses manufacturing or support material from the manufacturing base 2 or the layers of material which have already been deposited there.

The disclosure is not limited to manufacturing equipment with main manufacturing heads 3 and supporting manufacturing heads 4. In other embodiments, a single main manufacturing head or a plurality of main manufacturing heads are arranged such that different manufacturing materials can be used.

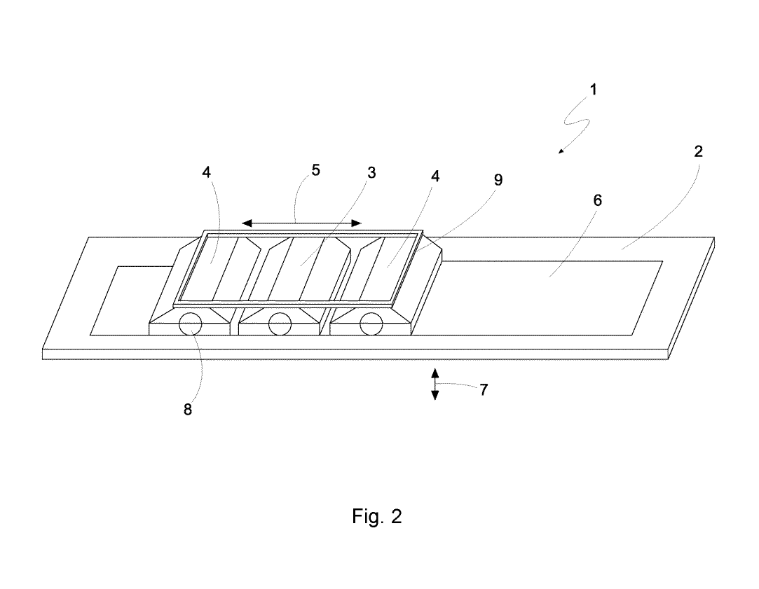

A further preferred embodiment of a prototyping device 1′ according to the disclosure is shown in FIG. 2. The prototyping device 1′ corresponds, in terms of its construction, to the differences in the construction of the prototyping device 1 pursuant to FIG. 1 as explained below. For identical components, the same reference numerals are used.

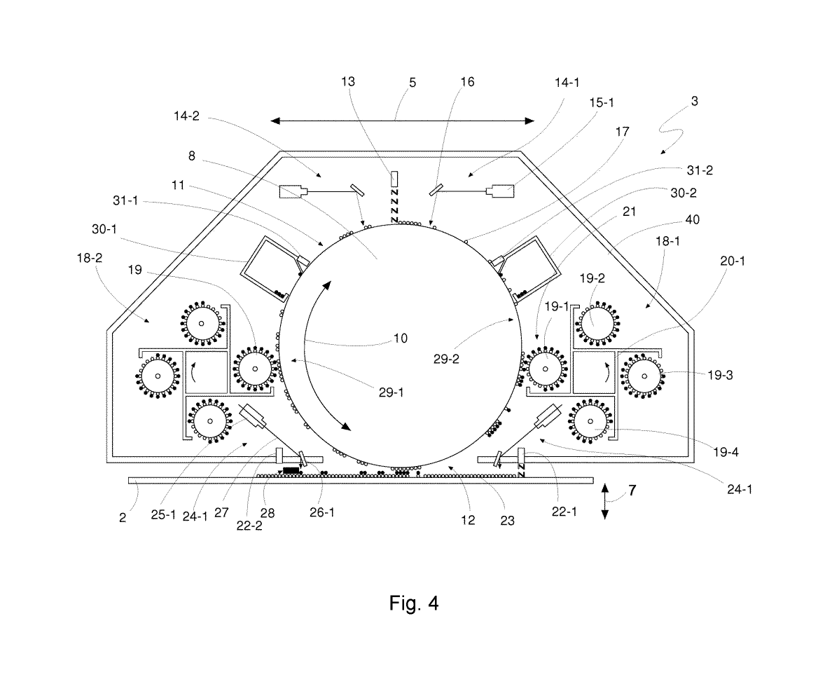

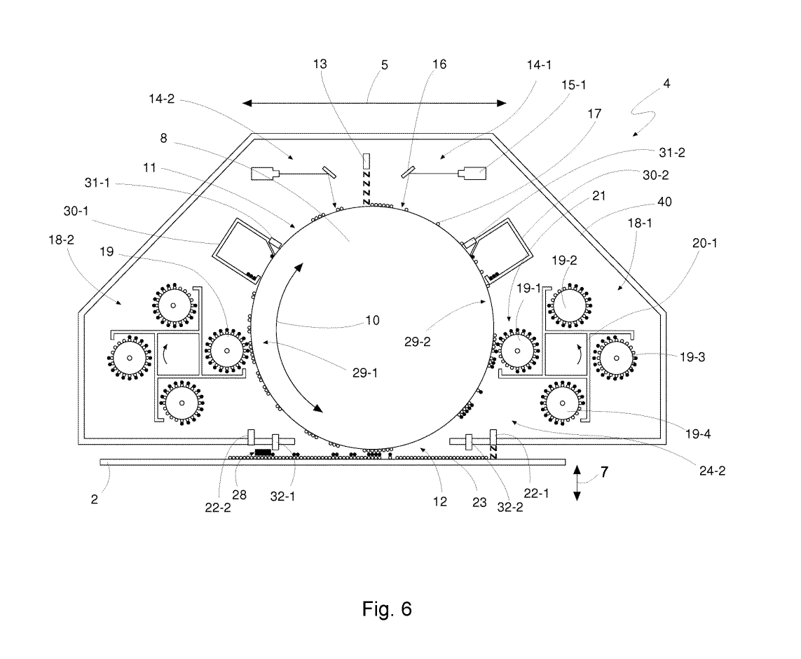

The prototyping device 1′ according to FIG. 2 has a main manufacturing head 3 and two supporting manufacturing heads 4, 4′ which are mounted on both sides of the main manufacturing head 3 to the frame 9. The work movement of the main manufacturing head 3 is thus coupled via the frame 9 with the work movement of the supporting manufacturing heads 4,4′ such that all manufacturing heads 3, 4, 4′ simultaneously coat the work area 6. The manufacturing heads are designed so as to be able to apply material in both work directions 5, i.e. in opposite directions of the working movement, as described below in FIG. 4 and FIG. 6. As a result, manufacturing and support material is stored in each working movement on the manufacturing location or the layers of material upon which deposits have already been placed, such that a doubling of the manufacturing rate of the prototyping device 1′ is provided. At the end of a work movement, the working direction 5 is changed and the manufacturing heads 3, 4, 4′ are moved in the opposite direction.

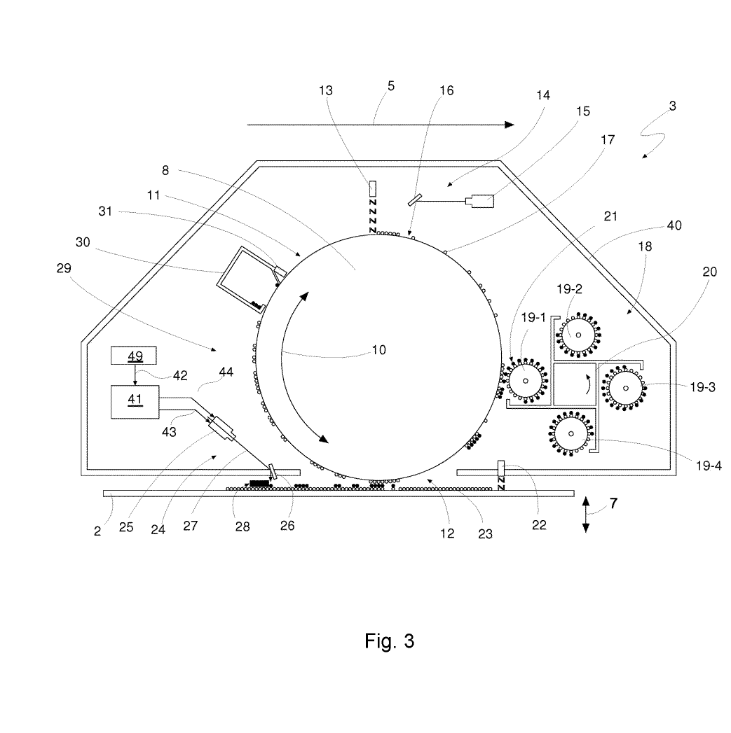

FIG. 3 shows a cross-section of a major manufacturing head 3 which operates in a working direction 5. The main manufacturing head 3 is moved in work direction 5 relative to the manufacturing location 2. The image drum 8 can be moved in a working direction of rotation 10, whereby the rotational speed of the image drum 8 is synchronised with the work movement in the work direction 5 such that the image drum 8 is passed over the manufacturing base 2.

The main manufacturing head 3 is configured such that the manufacturing material is receivable over a photoconductor 11 which is exposed according to the specified manufacturing grids for each layer selectively according to location and which is able to be transported to the manufacturing location, i.e. to the manufacturing base. The location-selective application of manufacturing materials to the manufacturing base 2 or the layers of material 12 which have already been deposited is based on the principle of electrophotography. In the illustrated embodiment, the image drum 8 is coated with a photoconductor 11, i.e. a photoelectrically active material. The image drum 8 is located rotatably in a housing 40 of the manufacturing head 3 in the working direction of rotation 10 and is located freely in the area of a material transfer 12 in relation to the manufacturing base 2. The transfer of material 12 is a free passage in the housing 40. The main manufacturing head 3 is able to move translationally with its housing 40 and, therefore, with the image drum 8 as well as all other devices of the manufacturing head 3 in the manner of a carriage relative to the manufacturing base 2 (FIG. 1).

The main manufacturing head 3 also comprises an electrical conditioning unit 13 for electrostatic charging of the photoconductor 11 of the image drum 8 and an exposure unit 14. This exposure unit 14 comprises means for the location-selective exposure of the photoconductor 11 of the image drum 8. The conditioning unit 13, which may also be referred to as a corotron, generates an electrostatic charge on the photoconductor 11 in the direction of the surface line, i.e. the portion of the image drum 8 which is parallel to the rotational axis of the image drum 8 and positioned opposite the conditioning unit 13. This conditioning unit 13 can be designed as a corotron with so-called corona wires. In further embodiments, a line of point charge diodes arranged in the axial direction of the image drum 8 is provided.

The exposure unit 14 is located downstream of the conditioning unit 13 in the working direction of rotation 10 and has means for the location-selective exposure of the photoconductor 11 of the image drum 8. This means that the exposure unit is exposed according to the predetermined manufacturing grids by the optical action of individual points, i.e. location-selective, of the facing surface line of the photoconductor 11 and thereby neutralises the electric charge. In the illustrated embodiment, the exposure unit 14 includes a laser 15 and an optical deflection device which is assigned to the laser 15 as a means for the location-selective exposure of the photoconductor 11 of the image drum. The deflection device is designed as a rotatable deflection mirror 15. The deflecting mirror 15 is kept in continuous circulation by means of a drive unit (not illustrated here), whereby the laser beam 17 of the laser 15 is moved back and forth on the photoconductor 11 in the manner of a laser scanner. This laser 15 is switched on and off by the control unit (not illustrated here) in accordance with the specified manufacturing grids such that a print image with neutral sites and charged sites is generated on the photoconductor 11. The sites which are electrically charged are represented in the diagram by an open circle 17. The laser 15 is preferably a fibre laser which, by means of a high-quality beam and a good electrical/optical efficiency, ensures optimal results in the location-selective fusing of manufacturing materials. In further embodiments, pulsed lasers are used, such as a CO2 laser or a Nd:YAG laser of the fuser unit as an actuator.

The exposure unit 14 designed as a laser scanner is able to produce printed images very quickly line by line on the photoconductor 11, as a result of which high manufacturing speeds can be achieved.

In one embodiment (not illustrated here), instead of the exposure unit 14 which is designed as a laser scanner, an exposure unit with selectively controllable light sources, in particular laser diodes (LED) is provided as an exposure unit. These LEDs are aligned in the axial direction of the image drum 8, as a result of which individual points of the photoconductor 11 can be neutralised in accordance with the control and activation of the respective LEDs.

To load the image drum 8 with manufacturing material, the manufacturing head includes a developing unit 18 which is located downstream from the exposure unit 14 in the operating direction of rotation 10 of the imaging drum 8. The developing unit 18 comprises at least one electrostatically chargeable transfer roller (in the present embodiment four transfer rollers 19-1, 19-2, 19-3, 19-4) for the reception and provision of manufacturing material. The transfer rollers 19-1, 19-2, 19-3, 19-4 are arranged parallel to the image drum 8 and make different manufacturing materials available. The transfer rollers 19-1, 19-2, 19-3, 19-4 are connected to a rotatably arranged transfer carousel 20 such that one transfer roller 19-1 in each case is movable in an active position adjacent to the image drum 8.

The transfer rollers 19-1, 19-2, 19-3, 19-4 are arranged rotatably and receive production material from a material container which is respectively assigned to each one at their periphery, and which is attached in opposition to the image drum 8 with the rotation of the transfer roller.

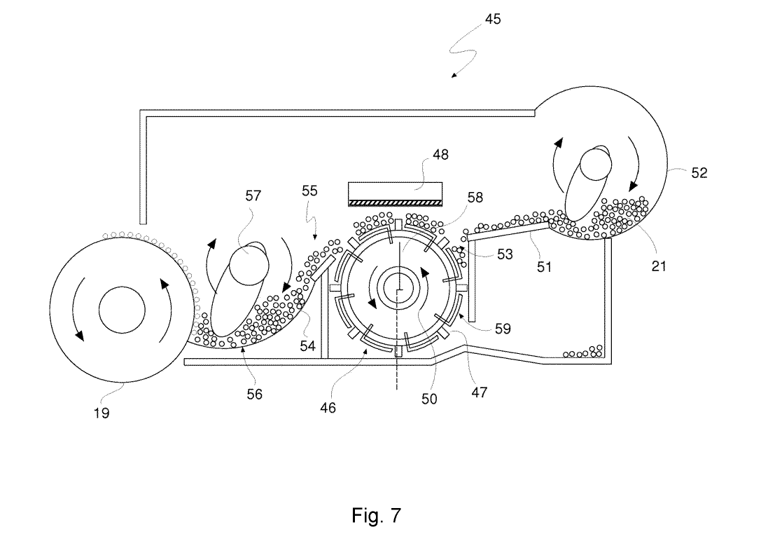

The manufacturing material is held on the respective transfer roller through static electricity. For this purpose, a corresponding loading unit is assigned to the transfer roller 19-1, 19-2, 19-3, 19-4. The charge of the manufacturing material at the manufacturing rollers is thereby electrically positioned opposite the charge of the photoconductor 11. At the locations charged by circles 17 corresponding to the exposed printing image, manufacturing material is transferred from the active transfer roller 19-1 to the image drum 8 selectively according to location. In the case of metallic manufacturing materials, the respective transfer roller is preceded by an induction device which, by means of an electric field, acts on the particles of the manufacturing material and promotes the later reception of the particles by the transfer roller 19-1. An induction device is described below by means of FIG. 7.

With the further movement of the image drum 8 in operating direction of rotation 10, the manufacturing material 21 is moved according to the filled-in circles in the direction of the material transfer 12. The manufacturing material 21 is advantageously provided in either granulated or powder form. In particular, for the arrangement of supporting material in each layer to be manufactured, liquid manufacturing materials are also advantageous. To this end, appropriate support manufacturing materials are used which can be passed selectively in accordance with location in accordance with the principle of electrophotography via the electrostatic charge of the photoconductor 11.

Finally, the manufacturing head includes an electric base conditioning 22 in the working direction of rotation 10 of the imaging drum 8 which is arranged before the material transfer 12 and acts in the direction of the manufacturing base 2. The base conditioning 22 is held on the housing of the manufacturing head. The base conditioner 22 can be equipped like a corotron with corona wires which ionise the manufacturing base 2 or the layers of material which have already been deposited thereupon. In another embodiment, the base conditioning 22 comprises a series of point charge diodes which are arranged in the axial direction of the image drum 8, i.e. in the transverse direction of the manufacturing base 2. The base conditioning is dimensioned such that the charges generated by the base conditioning (circles 23) are larger than the charges generated by the conditioning unit 13 (circles 17). In this way, it is ensured that the manufacturing material 21 is deposited at the periphery of the screen drum 8 in the opposition layer, i.e. in the closest distance from the manufacturing base 2, on the manufacturing base 2 or layers of material which have already been deposited thereupon or which automatically skips due to the electric charge.

The manufacturing head 3 particularly includes a fuser unit 24 for melting manufacturing material 21, which is adapted for the purpose of heating and melting the manufacturing material located at the respective grid positions 44. The fuser unit 24 is constructed and arranged such that the manufacture material 21 which has been stored from the image drum 8 on the manufacturing location or the material layers which had previously been deposited on the manufacturing base are able to be melted. The fuser unit 24 is therefore arranged downstream in the working direction of working rotation 10 of the imaging drum and disposed in the region of a bottom of the housing 40 of the manufacturing head 3. The fuser unit 24 is therefore movable from the manufacturing head 3 in the manner of a carriage over the material which has been deposited selectively according to location.

The fuser unit 24 of the main manufacturing head 3 comprises a laser 25, namely, in the illustrated embodiment, a pulsed CO2 laser, and an optical deflection which is assigned to the laser 25. The deflection in the illustrated embodiment is a rotatably assigned mirror, which deflects the laser beam 27 of the laser 25 in the direction of the manufacturing base 2. The mirror 26 is preferably a hexagonal mirror. The mirror 26 is always kept in a continuous rotary motion and, together with the laser 25, forms a laser scanner, whereby the laser beam 27 or its laser pulses can be deflected in rows which are located transversely to the direction 5. By means of suitable control, i.e. switching the laser 25 on and off, the laser is turned on upon reaching such locations where the manufacturing material 21, which had previously been deposited selectively according to location by the image drum 8, is to be melted. After the liquefaction through the action of the fuser unit 24, the manufacturing material 21 solidifies. The solidified portion of the manufacturing material is represented in the illustration by the filled-in rectangle 28.

The fuser unit 24 is controlled for each layer by means of a control unit 41 according to the manufacturing grids 49. The manufacturing grid 49 for individual layers of the work piece to be finished are specified by a piece of manufacturing software. The control unit 41 is developed so as to determine grid positions 44 and/or a power requirement 43 which is associated with the grid position 44 for the fuser unit 24 according to the predetermined manufacturing grid 49. A grid position 44 is understood to be the smallest cell of the manufacturing grid 49 which is controlled selectively according to location. This understanding affects both the location-selective storage of manufacturing materials 21 as well as the location-selective fusing by means of the fuser unit 24. The power demand 43 includes information about the desired power of the laser 25 and/or the temporal duration of the effect of the laser beam on the manufacturing material 21. The grid positions 44, at which the laser 25 is to be activated, as well as the energy requirement 43 associated with the respective grid position 44 are jointly stored in location-selective information 42 for the current manufacturing grid 49.

After passing the material transfer 12 and passing through a return portion 29 of the imaging drum 8, each peripheral portion of the image drum 8, i.e. the shell segments lying parallel to the axis of rotation of the image drum 8, reaches the conditioning unit 13 once again, where a new work cycle of the manufacturing head 3 starts. A material stripper 30 is arranged in the region of the return section 29, which lies between the material transfer 12 and the conditioning unit 13. The material stripper 30 limits a narrow gap to the surface of the imaging drum 8 and may prevent remaining material residues on the surface of the imaging drum 8 at the other transport. The material remains are rather mechanically separated from the surface and collected in material stripper 30. In further embodiments, other cleaning units may be provided, such as brushes or the like. In return section 29, a discharge unit 31 is finally arranged which may neutralise charges remaining on the photoconductor 11 (circles 17). In the illustrated exemplary embodiment, the discharge unit 31 is structurally connected to the material stripper 30 or the cleaning units.

In FIG. 4, a schematic cross-section of a supporting manufacturing head 4 is shown which, regarding the arrangement of image drum 8, conditioning unit 13, exposure unit 14, developing unit 18 and base conditioning 22, corresponds to the main manufacturing head 3 according to FIG. 3. A material stripper 30 and a discharging unit 31 are also arranged corresponding to the material stripper of the main manufacturing head 3 (FIG. 3). Instead of a transfer carousel 20 which functions like a revolver with four transfer rollers 19-1, 19-2, 19-3, 19-4, other numbers of transfer rolls can also be provided, particularly on the supporting manufacturing head 4. Particularly for series or mass manufacturing (“rapid manufacturing”), a single supporting material, such as a water-soluble adhesive or a similar bonding material, is often sufficient. In such embodiments of the support manufacturing head 4 according to the disclosure, a single transfer roller is provided instead of the transfer carousel 20. The transfer roller is charged with supporting material as already described for FIG. 3. This support material may be powdered, granular or liquid.

In contrast to the main manufacturing head 3, the supporting manufacturing head 4 includes a fuser unit 32, which comprises a heat source. The heat source is thereby matched to the intended support material in order to solidify the support material which is deposited from the image drum 8. This heat source preferably comprises one or more ultraviolet lamps, which act on the deposited material layer in a workspace which is transverse to the direction 5 of the supporting manufacturing head 4.

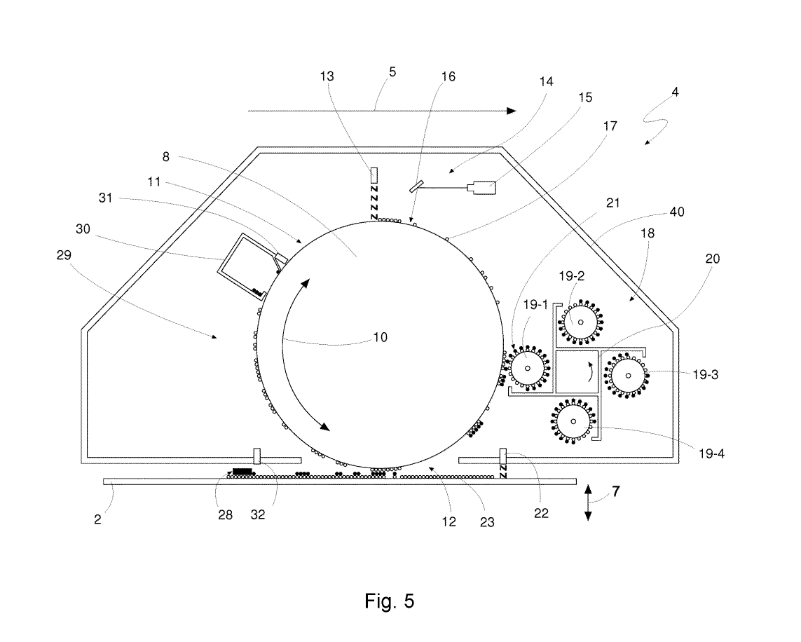

FIG. 5 shows a particularly advantageous embodiment of a main manufacturing head 4, which is designed for two opposite work directions 5. The prototyping device works through a main manufacturing head pursuant to FIG. 5 with a double manufacturing speed compared to a design with the manufacturing head pursuant to FIG. 3. The manufacturing head 4 in the embodiment pursuant to FIG. 5 includes, for a first work direction, a first device with conditioning unit 13, exposure unit 14-1, developer unit 18-1, base conditioning 22-1 and fuser unit 24-1 as well as a second device for a second working direction opposite the first working direction. The second device also includes the conditioning unit 13, an exposure unit 14-2, a developing unit 18-2, a base conditioning 22-2 and a fuser unit 24-2. The second device is essentially arranged symmetrical to the first device and the respective units arranged around the image drum 8. In the illustrated example, a common conditioning unit 13 is provided which is centrally located and in constant operation and which is conditioned in relation to the photoconductor 11 of the image drum 8. The conditioning unit 13, the imaging units 14-1, 14-2, the developer units 18-1, 18-2, the base conditionings 22-1, 22-2 and the fuser units 24-1, 24-2 of both devices for the respective work directions 5 are each identical in construction as well as developed and arranged in accordance with the description of FIG. 3.

Moreover, for each device, the main manufacturing head 3 comprises a cleaning unit, namely, in the illustrated embodiment, a material stripper 30-1, 30-2. In addition, the main manufacturing head 3 comprises two end load units 31-1, 31-2, which are arranged similarly to the construction according to FIG. 3 in the area of the material stripper 30-1, 30-2.

The image drum 8 of the main manufacturing head 3 according to FIG. 5 is operable in opposite working directions of rotation 10. After the main manufacturing head has reached the end of the work area 6 in a working direction 5 (FIG. 1, 2), the main manufacturing head 3 is moved in the opposite working direction of rotation, while the working direction of rotation 10 of the imaging drum is reversed. The two devices with conditioning units, exposure units, developing units, base conditionings and fuser units can be activated alternatively. By switching the operating direction 5 of the manufacturing head and the consequent reversal of the working direction of rotation 10 of the image drum 8, the previously active device is turned off and the other device is activated.

FIG. 6 shows a supporting manufacturing head 4 which, similarly to the main manufacturing head 3 according to FIG. 5, is designed for opposite directions of work 5. The supporting manufacturing head 4 according to FIG. 6 includes a first device with conditioning unit 13, exposure unit 14-1, developer unit 18-1, base conditioning 22-1 and fuser unit 24-1. This first device is activated in a working rotation direction 10 according to the description of the supporting manufacturing head according to FIG. 4. The supporting manufacturing head 4 according to FIG. 6 comprises a second device with an exposure unit 14-2, a developer unit 18-2, base conditionings 22-2 and a fuser unit 24-2, which can be activated alternatively of the first device. It is activated by switching the working direction of rotation 10 of the imaging drum 8. Upon achieving an end of the work area 6 (FIG. 1, FIG. 2) and a switching of the working direction of the manufacturing heads, the control unit of the prototyping device (not illustrated here) accordingly controls the working direction of rotation 10 of the image drum 8 and activates the other device.

With the prototyping device according to the disclosure, different manufacturing materials can be combined with rapid and accurate manufacturing. In addition, colouring of individual manufacturing materials by means of colour particles is possible. Compared to conventional rapid prototyping processes, the prototyping device according to the disclosure makes an enlarged construction area possible. In particular, high manufacturing speeds are achieved, since the manufacturing material is not heated in layers and—as, for example, in the selective laser sintering or laser melting—a cooling of the just-processed material layer has to be waited for. Another advantage of the prototyping device according to the disclosure is the reduction of material waste in the case of various materials, since, with the prototyping device according to the disclosure, binder-free materials are used and no impurities occur.

The fusing of the main manufacturing head with a laser allows a complete melting of the material portions which have been deposited selectively according to location, whereby alloys are joined together in a simple manner when using multiple manufacturing materials. With appropriately fine-grained or liquid manufacturing materials, very fine surface structures can be manufactured.

The formation of the prototyping device with one or more main manufacturing heads and one or more support manufacturing heads 4, i.e. the introduction of a plurality of components, allows the use of various adhesives in order to realise various functions, such as on highly loaded components.

For each transfer roller 19-1, 19-2, 19-3, 19-4, manufacturing material can be supplied over an induction device 45, which is designed for generating an electric field in the conveying path of the manufacturing material 21. FIG. 7 shows an embodiment of an induction device 45 to the electrostatic induction of the manufacturing material 21 to be conveyed to the transfer roller 19. The induction device 45 comprises a bladed conveyor wheel 46, which is drivable in rotational direction 50, and blades 47 on the periphery for the transport of manufacturing material 21. In the upper sector of the feed wheel 46, i.e. located over the axis of rotation, a feed chute 51 is located in the rear of the direction of rotation 50. The feed chute 51 feeds previously introduced manufacturing material 21 from a reservoir 52 to the feed wheel 46, such that continuous manufacturing material 21 falls into the blades 47 when the respective blade is in a loading position 53 adjacent to the feed chute 51. On the opposite side of the feed wheel 46, an electrically isolated chute 54 is also arranged in the upper sector of the feed wheel 46, whereby, in a dispensing position 55 of the blades 46, in which the respective blade 46 is opposite the slide 54, the material freight of the blade 46 falls into the chute 54 and is eventually transported to the transfer roller 19.

The induction device 45 comprises an electrical voltage source 48, which is disposed over the feed wheel 46 and is centrally located in the present embodiment. This voltage source 48 is so close to the feed wheel 46 that its electric field detects the region of the blades 47.

The electrically isolated blades 47 therefore pass through the electric field of the power source 48 between the loading position 53 and the dispensing position 55, whereby the electric field acts on and electrostatically induces the passing manufacturing material 21 (so-called induction).

In the illustrated embodiment, the electrostatically charged manufacturing material 21 slides over the electrically isolated slide 54 in a likewise electrically insulated feed tank 56. In the feed tank 56, a conveyor 57 is arranged which promotes the manufacturing material 21 with a circular feeding motion to the transfer roller 19.

The feed wheel 46 and the blades 47 are electrically insulated. The blades 47 can thereby be recessed in the shell of a roll. In one embodiment, the blades 47 and the recesses have a conductive bottom plate 59, which is located on an insulated layer. During the orbital motion of the feed wheel 46, the base plate comes into contact with a ground probe 58, such that unwanted charge distributions are conducted away.

What is claimed is:

1. Rapid prototyping device for the layered additive manufacturing of three-dimensional objects, with at least one manufacturing base and at least one manufacturing head for the arrangement of granular, powder or liquid manufacturing material on the manufacturing base or the material located on the manufacturing base, which is developed to dispense manufacturing materials in a location-selective manner at the manufacturing site in grid positions according to predetermined manufacturing grids for each layer, whereby the manufacturing head comprises at least one fuser unit for the fusing of manufacturing material, whereby the manufacturing base and the manufacturing head are located such that they can be slid against each other both in accordance with a direction of travel in the plane of a layer as well as in a feed direction relative to the thickness of the layers, whereby the fuser unit is developed to fuse to the respective grid positions and in a location-selective manner the manufacturing materials which is located there, namely to impart energy at the concrete working position corresponding to the grid position in the manufacturing grid in order to heat and melt the manufacturing material, wherein the fixing unit comprises a laser and an optical deflection device assigned to the laser, in particular a rotatably mounted deflecting mirror, wherein the laser can be controlled and activated by the control unit according to the respective manufacturing grid.

2. The prototyping device according to claim 1, wherein the fuser unit is controllable for the respective layer by means of a control unit, which is developed so as to determine, according to the predetermined manufacturing grids, grid positions and/or an energy requirement connected with the grid position for the fuser unit.

3. The prototyping device according to claim 1, wherein the manufacturing head is designed such that the manufacturing material can be received and transported to the place of manufacture over an exposed photoconductor according to the specified manufacturing grids for the respective layer in a location-selective manner, whereby the manufacturing head has the following features for this purpose: an electrophotographic imaging drum having a photoconductor on its shell and being free in the area of a material handling of the manufacturing head with respect to the manufacturing base, at least one electrical conditioning unit for the electrostatic charging of the photoconductor of the image drum, at least one the exposure unit located downstream of the conditioning units in the working direction of rotation of the image drum, which has means for the location-effective exposure of the photoconductor of the image drum, at least one developer unit located downstream of the exposure units in the operating direction of rotation of the image drum with an electrostatically chargeable transfer roller for providing electrostatically charged manufacturing materials which is located parallel to the image drum, at least one electrical base conditioning arranged in the working direction of rotation of the image drum prior to the material transfer and acting in the direction of the manufacturing base.

4. The prototyping device according to claim 3, wherein the transfer roller is associated with a loading unit.

5. The prototyping device according to claim 3, wherein manufacturing material can be supplied to the transfer roller via an electrical induction device, which is developed for generating an electric field in the conveying path of the manufacturing material.

6. The prototyping device according to claim 5, characterised in that the electrical induction device comprises a bladed conveyor wheel, the blades of which are electrically insulated and pass through the electric field of an electric voltage source between a loading position and a dispensing position.

7. A prototyping device according to claim 3, wherein the manufacturing head has, for a first working direction, a first device with at least one conditioning unit exposure unit, developer unit, base conditioning and fuser unit and for a second working direction opposite the first working direction, a second device each with at least one conditioning unit, exposure unit, developer unit base conditioning and fuser unit which is essentially positioned symmetrical to the first device.

8. The prototyping device according to claim 1, wherein at least one manufacturing head as the main manufacturing head for manufacturing materials and a controllable manufacturing head coordinated with the main manufacturing head as a supporting manufacturing head for supporting material.

9. The prototyping device according to claim 8, wherein the supporting manufacturing head corresponds to the main manufacturing head relative to the array of image drum, conditioning unit, exposure unit, developer unit and base conditioning.

10. The prototyping device according to claim 8, wherein the at least one fuser unit of the supporting manufacturing head comprises a heat source.

11. The prototyping device according to claim 3, wherein the base conditionings are configured such that an amount of the electric charge which can be produced by the base conditioning is greater than an amount of the charge of the image drum which can be produced from the conditioning unit.

12. The prototyping device according to claim 3, wherein the conditioning unit and/or the base conditioning are both developed either to produce a negative electrostatic charge or to produce a positive electrostatic charging or to be switchable between a setting for generating a negative electrostatic charge and a setting for generating a positive electrostatic charge.

13.

14. A method for operating a prototyping device according to claim 1, wherein the control unit which is allocated to the fuser unit provides grid positions to the fuser unit on which the fuser unit is activated according to the manufacturing grid.

15. The method according to claim 14, wherein the control unit of the fuser unit defines power requirements for the respective grid position.
